(19) United States
(12) Patent Application Publication
(10) Pub. No.: US 2005/0261978 A1
(43) Pub. Date: Nov. 24, 2005

(54) Method for tendering for remaining seats of higher class in an airliner which is about to take off or has just taken off

(76) Inventor: Chichuan Hung, Taipei (TW)

Correspondence Address: BRUCE H. TROXELL, SUITE 1404, 5205 LEESBURG PIKE, FALLS CHURCH, VA, 22041, US

(21) Appl. No.: 10/848,142

(22) Filed: May 19, 2004

(51) Int. Cl. G06F 17/60

(52) U.S. Cl. 705/26

(57) ABSTRACT

A method for tendering for remaining seats of higher class in an airliner which is about to take off or has just taken off. The method is performed via a network trade platform. The method includes steps of: (a) an airline transmits data of remaining seats of first class chamber or business chamber in an airliner which is about to take off or has just taken off to a tender website of internet or a server of internal network on the airliner or a tender website of a wireless telecommunication network; (b) during a set period before or after the airliner takes off, authorized passengers in the economy chamber or business chamber use the terminals of the seats via the tender website of the network system to start tendering for the remaining seats of higher class; (c) after the tendering procedure is completed, the passengers obtaining the remaining seats pay the difference between the prices by way of credit card via the terminals; (d) after paid, the passenger seat list on the website is changed and transmitted to the airline; and (e) the airline transmits the data of switch of seats back to the airliner. After the above trade is finished, the service workers on the airliner induct the passengers to the new seats.

### BACKGROUND OF THE INVENTION

The present invention is related to a method for tendering for remaining seats of higher class in an airliner which is about to take off or has just taken off, and more particularly to a method for via a network trade platform tendering for remaining seats of higher class in an airliner which is about to take off or has just taken off.

It is known that in an airliner, there are first class chamber, business chamber and economy chamber. It often takes place that after the airliner takes off, many vacancies are left in the first class chamber and business chamber without being utilized. This leads to loss of the airline and waste of resource.

### SUMMARY OF THE INVENTION

It is therefore a primary object of the present invention to provide a method for tendering for remaining seats of higher class in an airliner which is about to take off or has just taken off. By means of this method, the better seats on the airliner can be fully economically utilized to increase income of the airline and avoid waste of resource.

According to the above object, the method of the present invention includes steps of: (a) an airline transmits data of remaining seats of first class chamber or business chamber in an airliner which is about to take off or has just taken off to a tender website of internet or a server of internal network on the airliner or a tender website of a wireless telecommunication network; (b) during a set period before or after the airliner takes off, authorized passengers in the economy chamber or business chamber use the terminals of the seats via the tender website of a network system to start tendering for the remaining seats of higher class; (c) after the tendering procedure is completed, the passengers obtaining the remaining seats pay the difference between the price of the obtained seat and the price of the original seat by way of credit card via the terminals; (d) after paid, the passenger seat list on the website is directly changed and transmitted to the airline for data processing; and (e) the airline transmits the data of successful switch of seats back to the airliner to complete the online trade. After the above trade is finished, the service workers on the airliner induct the passengers to the new seats.

The difference paid by the passengers obtaining the remaining seats is less than the original difference between the prices. Therefore, the passengers are attracted to tender for the seats of higher class.

The present invention can be best understood through the following description and accompanying drawings wherein:

### BRIEF DESCRIPTION OF THE DRAWING

FIG. 1 is a flow chart of the method for tendering for remaining seats of higher class in an airliner which is about to take off or has just taken off of the present invention.

### DETAILED DESCRIPTION OF THE PREFERRED EMBODIMENT

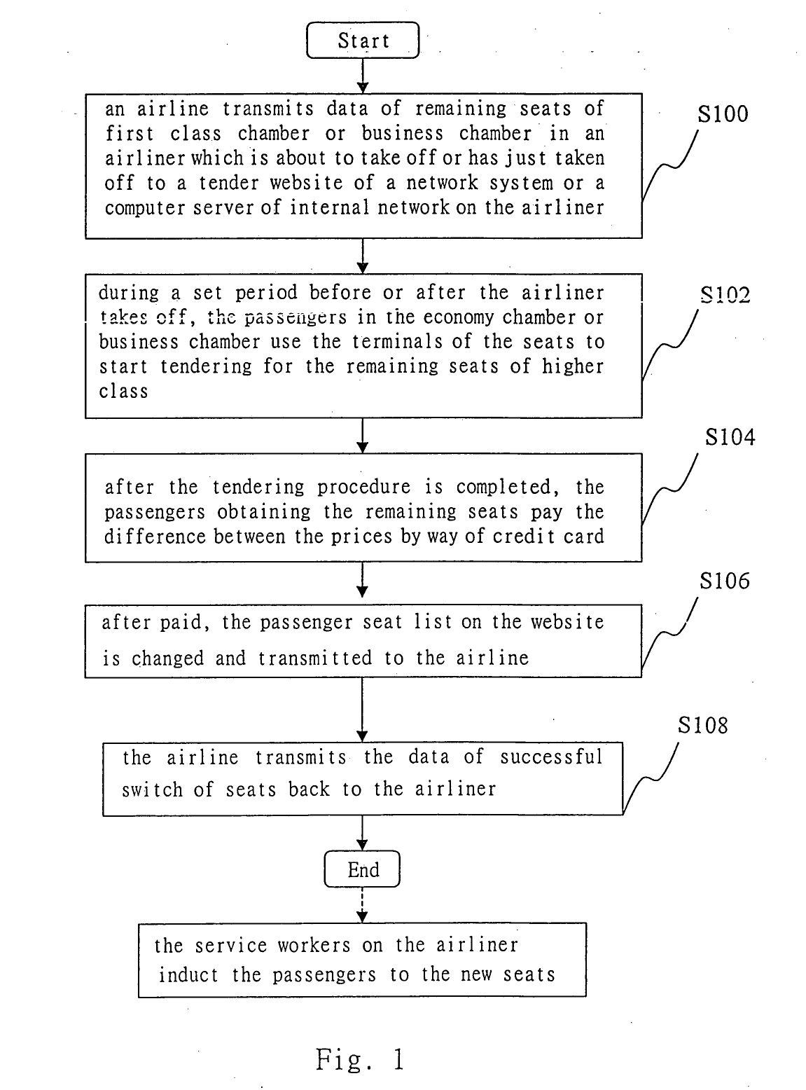

Please refer to FIG. 1. According to the present invention, the method for tendering for remaining seats of higher class in an airliner which is about to take off or has just taken off includes the following steps:

Step S100: The airline transmits the data of the remaining seats of higher class in the airliner which is about to take off or has just taken off to a network system such as internet, internal network on the airliner or wireless telecommunication network.

Step S102: During a set period before or after the airliner takes off, the authorized passengers in the economy chamber or business chamber use the terminals of the seats via the tender website of the network system to start tendering for the remaining seats of higher class.

Step S104: After the tendering procedure, the passengers obtaining the remaining seats of the first class chamber and business chamber pay the difference between the prices of the obtained seat and the original seat by way of credit card via the terminals.

Step S106: After paid, the passenger seat list on the website is changed and transmitted to the airline for data processing.

Step S108: The airline transmits the data of successful switch of seats back to the airliner to complete the online trade.

After the above trade is finished, the service workers on the airliner induct the passengers to the new seats.

According to the above method, the better seats on the airliner can be fully economically utilized to avoid vacancy of the seats of high class and waste of resource.

The above embodiment is only used to illustrate the present invention, not intended to limit the scope thereof. Many modifications of the above embodiment can be made without departing from the spirit of the present invention.

1. A method for via network trade platform tendering for remaining seats of higher class in an airliner which is about to take off or has just taken off, said method comprising steps of:
(a) an airline transmits data of remaining seats of first class chamber or business chamber in an airliner which is about to take off or has just taken off to a tender website of internet or a server of internal network on the airliner or a tender website of a wireless telecommunication network;
(b) during a set period before or after the airliner takes off, authorized passengers in the economy chamber or business chamber use the terminals of the seats via the tender website of a network system to start tendering for the remaining seats of higher class;
(c) after the tendering procedure is completed, the passengers obtaining the remaining seats pay the difference between the price of the obtained seat and the price of the original seat by way of credit card via the terminals;
(d) after paid, the passenger seat list on the website is directly changed and transmitted to the airline for data processing; and
(e) the airline transmits the data of successful switch of seats back to the airliner to complete the online trade, whereby after the above trade is finished, the service workers on the airliner induct the passengers to the new seats.

2. The method as claimed in claim 1, wherein in step (b), the network system is internet.

3. The method as claimed in claim 1, wherein in step (b), the network system is an internal network of the airliner.

4. The method as claimed in claim 1, wherein in step (b), the network system is a wireless telecommunication network.

5. The method as claimed in claim 1, wherein in step (c), the difference paid by the passengers obtaining the remaining seats is less than the original difference between the prices.
